(19) United States
(12) Patent Application Publication
(10) Pub. No.: US 2009/0135451 A1
(43) Pub. Date: May 28, 2009

(54) IMAGE FORMING APPARATUS, CONTROL METHOD THEREFOR, AND PROGRAM

(75) Inventor: Hajime Ohno, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/064,306

(22) PCT Filed: Sep. 11, 2006
(86) PCT No.: PCT/JP2006/318448

§ 371 Date: Feb. 20, 2008

(30) Foreign Application Priority Data
Sep. 13, 2005 (JP) 2005-265941

(51) Int. Cl. H04N 1/00

(52) U.S. Cl. 358/434

(57) ABSTRACT

According to this invention, when executing an application corresponding to a service provided by a copier, the application calls a function prepared in the multi-functional peripheral in correspondence with the service. After calling the function, a charge monitoring layer operates a charge information table (S501), and determines whether to charge a user for the function (S502). If the user is charged for the function, the charge monitoring layer acquires charge information and displays a fee request window (S503). After the user pays the fee, the application executes the function (S504).

### TECHNICAL FIELD

The present invention relates to a pay image forming apparatus installed in a public environment, and a control method therefor and, more particularly, to an image forming apparatus which charges a user for a function for use and executes the function after payment, a control method therefor, and a program.

### BACKGROUND ART

There has been a copier which is installed in a public environment and used by collecting a charge for using the copier from a user. When the user performs a copy operation, the coin-operated copier confirms whether the user inserts enough money into the coin box for managing money payment. If the user inserts enough money, the copier executes a copy process, and subtracts a set charge from the amount of money inserted in the coin box upon completion of the process.

There is also proposed a method of counting the number of copies by a counter and charging a user in accordance with the counter value. Some of these copies allow additionally installing functions and application programs, and also allow adding a counter in accordance with installation of a function or application program (see, e.g., Japanese Patent Application Laid-open No. 2003-216392). This type of copier counts the numbers of executed functions, application programs, and the like by the counter, and charges a user in accordance with the counter value.

However, none of the conventional charging methods is appropriate for public use of a function-enhanced copier. For example, the above-mentioned coin-operated copier charges a user only for the number of copies, and cannot charge him for a function other than copying.

The copier in Japanese Patent Application Laid-open No. 2003-216392 adopts a counter, charges a user after an actual process, and thus can charge him for an enhanced function. However, to use this copier in a public environment, the administrator must monitor fulfillment of payment. It is conventionally difficult to provide a function-enhanced copier for pay in a public environment without any administrator.

Conventionally, provided functions (services) and their payment structure are fixed, and to add a new service, the charging system must be built in accordance with the service. It is expected that the functions of copiers will be enhanced more and more in the future, and paid services provided by copiers will increase, too. If, however, services and their payment structure are fixed like the conventional copier, adding new functions requires much labor and high cost.

### DISCLOSURE OF INVENTION

The present invention has been made in consideration of the above situation, and has as its object to provide an image forming apparatus such as a copier which can charge a user for not only copying but also new functions and is suited to public use by collecting a charge every time the user uses the image forming apparatus, a control method therefor, and a program. It is another object of the present invention to provide an image forming apparatus such as a copier which provides a platform having a charging mechanism shared between provided functions and thereby can prevent an increase in the cost of application development accompanying a charging process for a new function, a control method therefor, and a program.

It is still another object of the present invention to provide a mechanism of specifying a function used by an application program and presenting, to a user before executing a service, a proper charge corresponding to the use status of various functions including a program and the like installed in a multi-functional peripheral.

In order to achieve the above objects, the present invention comprises the following arrangement. That is, there is provided an image forming apparatus capable of operating an application program of charging a user for a function for use, comprising

detection means for detecting a call for an application program interface (API) by the application program,

paid-function determination means for determining a paid function among functions used by the API in accordance with the call in response to detection of the API call by the detection means, and

charge determination means for determining whether charging is executable for the paid function determined by the paid-function determination means.

There is provided an image forming apparatus having an application platform for operating an application program of charging a user for a function for use, the application platform comprising

account data adapted to identify a target paid function,

charge monitoring means for monitoring execution of the paid function by referring to the account data, and

determination means for, when the charge monitoring means detects execution of the paid function, determining whether charging is executable, by executing a charge library.

There is provided an image forming apparatus having an application platform for operating an application program of charging a user for a function for use, the application platform comprising

an account table adapted to identify a target paid function,

declaration storage means for storing a declared function and an amount of money for a charge of the declared function in accordance with a declaration of calling the paid function by the application program,

payment storage means for displaying an amount of money corresponding to the paid function stored in the declaration storage means in accordance with a totalization message by the application program, and when the user pays the amount of money, storing that the user pays the amount of money, and

determination means for, when the application program is to execute the paid function, determining whether the user has paid the amount of money in correspondence with the application program,

wherein when the user is determined to have paid the amount of money, the user is permitted to execute the paid function.

According to the present invention, when a new paid service is added to an image forming apparatus such as a copier, the burden of application development accompanying a charging process for the service can be reduced.

The present invention can provide an image forming apparatus such as a copier which is suited to public use by collecting the charge of a service every time the user uses the image forming apparatus.

Even when one service utilizes a plurality of paid functions, the image forming apparatus can unitarily charge a user for them, improving user friendliness.

Further features of the present invention will become apparent from the following description of exemplary embodiments (with reference to the attached drawings).

### BRIEF DESCRIPTION OF DRAWINGS

FIG. 1 is a view of the network configuration of a musical score printing service;

FIG. 2 is a table showing an example of a charge information table in a charge information server;

FIG. 3 is a block diagram of the software arrangement of a multi-functional peripheral;

FIG. 4 is a schematic view of the software arrangement of the multi-functional peripheral for the musical score printing service;

FIG. 5 is a flowchart of a charging process when calling a target paid function in the first embodiment;

FIG. 6 is a view showing an example of a payment request window for the musical score download charge;

FIG. 7 is a view showing an example of a payment request window for the musical score print fee;

FIG. 8 is a block diagram of a software arrangement in the second embodiment;

FIG. 9 is a table showing an example of a declaration storage table;

FIG. 10 is a view showing an example of a total payment request window;

FIG. 11 is a flowchart of a charging process when calling a target paid function in the second embodiment;

FIG. 12 is a flowchart of a totalization process in the second embodiment;

FIG. 13 shows a charge information table management window;

FIG. 14 is a flowchart of a charge information table change process;

FIG. 15 is a block diagram of the hardware arrangement of the multi-functional peripheral;

FIG. 16 is a perspective view of the outer appearance of the multi-functional peripheral; and

FIG. 17 is a flowchart of a process by a platform program and musical score printing application.

### BEST MODE FOR CARRYING OUT THE INVENTION

### First Embodiment

The first embodiment will exemplify a service of downloading a musical score from a server on a network into a copier (or a digital multi-functional peripheral) installed at a convenience store or the like, and printing the musical score.

This service includes:

1. to download a list of available musical scores,
2. to prompt a user to select a musical score from the list,
3. to download the selected musical score, and
4. to print the musical score on an A3 print sheet.

This service charges a user a predetermined service fee of, e.g., ¥500 for one musical score, and a predetermined print fee of, e.g., ¥10 for one print sheet. The number of print sheets changes depending on the length of a musical score.

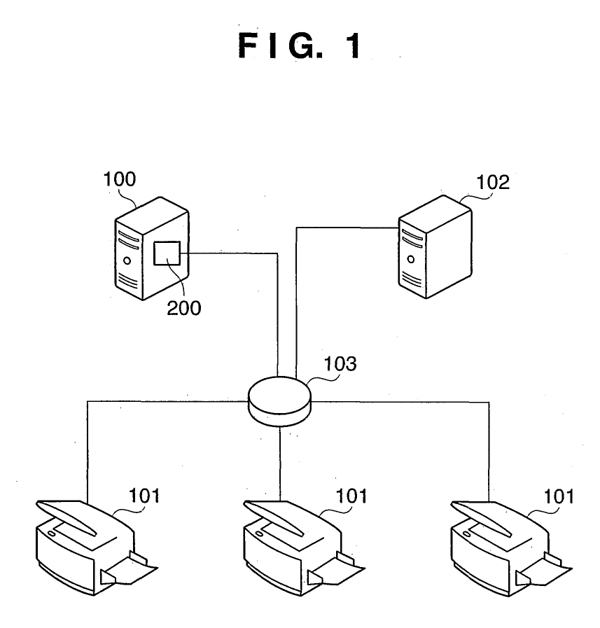

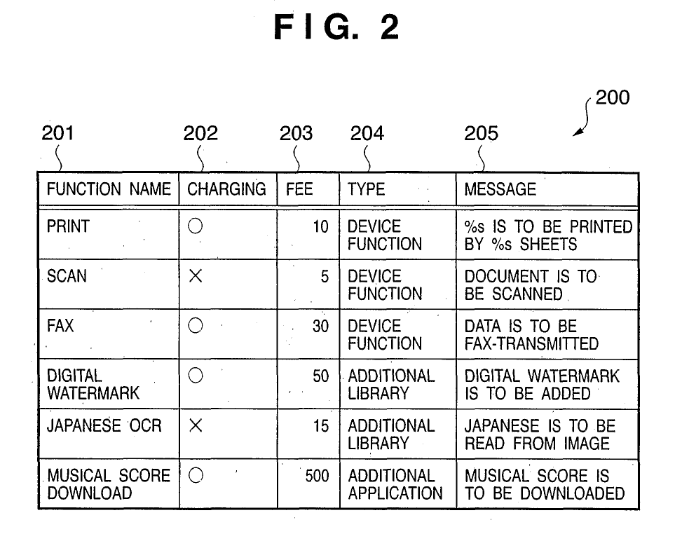

FIG. 1 is a view of the network configuration of convenience stores which provide the musical score printing service. A charge information server 100 at the head office of convenience stores holds a charge information table 200 shown in FIG. 2. The charge information server 100 unitarily manages, for example, information on the target objects and fees of services provided by a multi-functional peripheral 101 at each convenience store. The charge information table 200 saves pieces of charge information of the print, scan, and facsimile functions originally provided by the multi-functional peripheral. In addition, the charge information table 200 also holds charge information of a function unique to a service using a library program or application program which is provided by a third party and performs a unique process. That is, in the first embodiment, the multi-functional peripheral 101 provides a musical score printing service, and the charge information table 200 saves, e.g., the fee of musical score download which is a function unique to the service. The first embodiment is also applicable to a copy service and the like in addition to the musical score printing service.

A musical score server 102 saves musical score data which is downloaded by each multi-functional peripheral 101 and is in a printable form. The servers 100 and 102 and the multi-functional peripheral 101 connect to each other by a network 103.

The charge information table 200 shown in FIG. 2 will be explained. The charge information table 200 holds a function name 201, charge flag 202, function fee 203, function type 204, and display message 205 for each function provided by the multi-functional peripheral 101. The function name 201 is a function identification name, represents an ordinary name in FIG. 2, but suffices to be identification information unique to each function. The function name 201 may be omitted by forming a table so as to identify a function by an offset from the start of the charge information table 200.

The charge flag 202 represents whether to charge a user for a function. In FIG. 2, “o” means charging a user for a function. The fee 203 represents the unit cost of a function. For example, for the print function, the unit cost per sheet is set to ¥10. Although the unit cost of printing changes depending on the size, color/monochrome, and the like, the first embodiment simplifies the unit cost for descriptive convenience. Based on the premise of the embodiment, the fee of the musical score download function is ¥500. The type 204 represents a layer for executing a function. Printing, scanning, and facsimile are described as device functions because they are executed by hardware devices of the multi-functional peripheral 101. Libraries and applications can use device functions. To the contrary, a digital watermark and OCR function are provided as software libraries to the multi-functional peripheral, and are described as additional libraries. Applications can use libraries. Musical score download is implemented by an application and described as an additional application. The application forms a unit of services provided to a user. The type suffices to be unique identification information.

The display panel of the multi-functional peripheral displays the message 205 in executing a corresponding function. For example, the charge information table 200 saves a message “% s is to be printed by % s sheets.” for the print function. In this case, each % s is a variable, the first % s exhibits the sheet size, and the second % s exhibits a message replaced with the sheet count.

<Hardware Arrangement of Multi-Functional Peripheral (Image Forming Apparatus)>

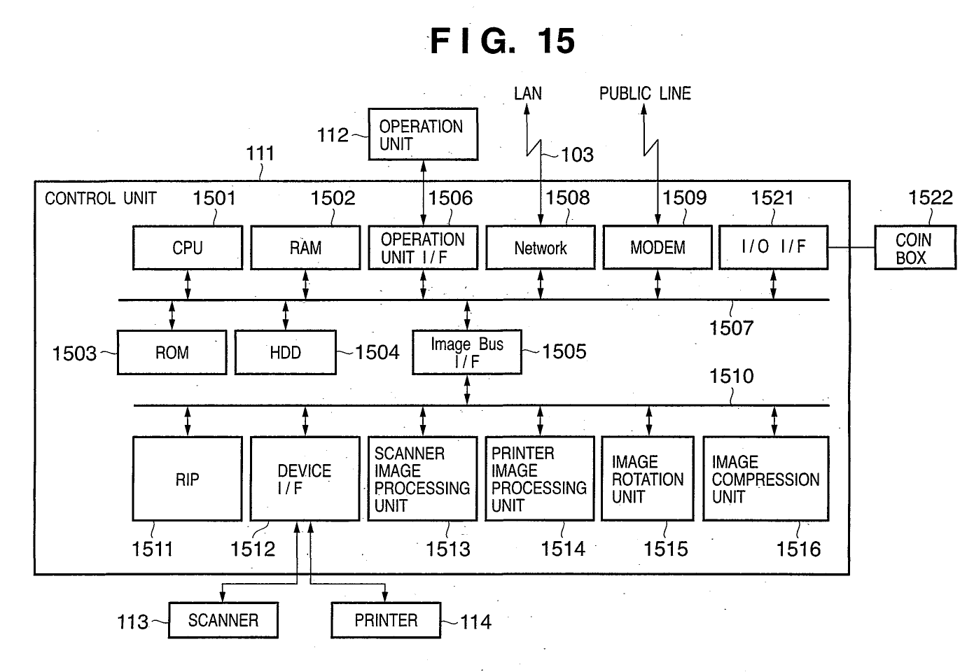

FIG. 15 is a block diagram showing the hardware arrangement of the multi-functional peripheral 101. A control unit 111 connects to a scanner 113 serving as an image input device and a printer 114 serving as an image output device, and connects to a LAN 103 and a public line (WAN). The control unit 111 inputs/outputs image information and device information.

A CPU 1501 executes a program stored in a RAM 1502 to control the overall control unit 111 or implement functions of the multi-functional peripheral. The CPU 1501 executes a process associated with a flowchart to be described later. The RAM 1502 is a system work memory for storing data and programs used by the CPU 1501 for an operation. The RAM 1502 is also an image memory for temporarily storing image data. A ROM 1503 is a boot ROM which stores the boot program of a system. An HDD 1504 is a hard disk drive which stores system software and image data.

An operation unit I/F 1506 interfaces between the control unit 111 and an operation unit (UI) 112, and outputs, to the operation unit 112, image data to be displayed on the operation unit 112. The operation unit I/F 1506 transmits information input by a user via the operation unit 112 to the CPU 1501. The operation unit displays a message which prompts a user to pay the fee of a service.

A network interface (Network) 1508 manages control with the LAN 103 and inputs/outputs information to/from the LAN 103. The network interface 1508 connects the control unit 111 to the servers 100 and 102. The network interface 1508 mediates access to the charge information table 200 and acquisition of musical score data. A modem (MODEM) 1509 manages connection to a public line and inputs/outputs information to/from the public line. The modem 1509 transmits/receives facsimile data. These devices are arranged on a system bus 1507.

An image bus interface (Image Bus I/F) 1505 is a bus bridge which connects the system bus 1507 to an image bus 1510 for transferring image data at high speed, and converts the data structure. The image bus 1510 is formed from a PCI bus or IEEE-1394.

The image bus 1510 connects the following devices. A raster image processor (RIP) 1511 rasterizes a PDL code transmitted from a network into a bitmap image. A device I/F 1512 connects the control unit 111 to the scanner 113 and printer 114 serving as image input and output devices, and performs synchronous/asynchronous conversion of image data.

A scanner image processing unit 1513 corrects, processes, and edits input image data. A printer image processing unit 1514 corrects printout image data and converts the resolution in accordance with the performance of the printer 114. An image rotation unit 1515 rotates image data. An image compression unit 1516 compresses/decompresses multilevel image data by JPEG, and compresses/decompresses binary image data by JBIG, MMR, or MH.

An I/O interface 1521 connects to a coin box 1522, and is used to control the coin box 1522 by the control unit 111. Control of the coin box is identical to the conventional one. For example, the control unit 111 controls operations such as read of an inserted amount of money and return of the change of a designated amount of money.

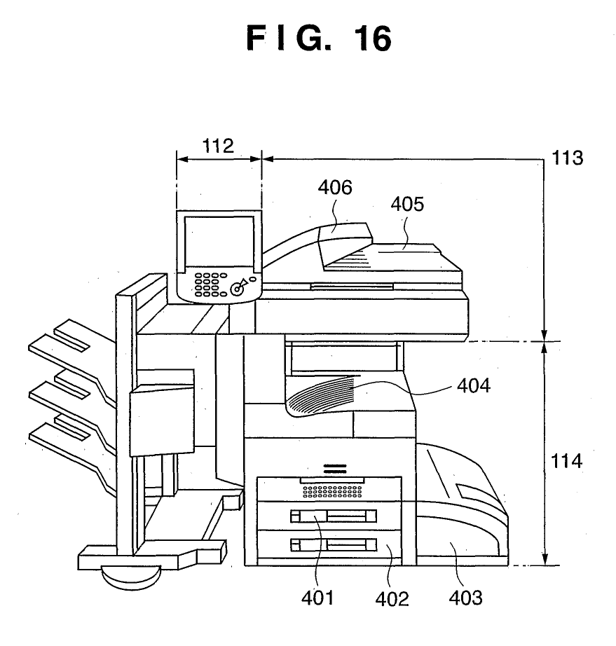

FIG. 16 is a perspective view showing the outer appearance of the multi-functional peripheral 101. The scanner 113 serving as an image input device illuminates an image on a document sheet, and scans a 13D line sensor (not shown) to generate raster image data.

The printer 114 serving as an image output device prints raster image data on a paper sheet. The printing method includes an electrophotographic method using a photosensitive drum and photosensitive belt, and an ink-jet method of discharging ink from a small nozzle array to directly print on a paper sheet, and either method can be adopted. Note that printing starts in accordance with an instruction from the CPU 1501. The printer 114 has a plurality of feed stages so as to allow a user to select different sheet sizes or different sheet orientations, and comprises corresponding sheet cassettes 401, 402, and 403. A delivery tray 404 receives a printed paper sheet.

The user selects a desired service from a menu displayed on the operation unit 112. For example, the user selects copying, inserts a displayed amount of money into the coin box, and executes copying. At this time, the user sets document sheets on a tray 406 of a document feeder 405, and designates the start of scanning on the operation unit 112. In accordance with this designation, the CPU 1501 of the control unit 111 gives an instruction to the scanner 113. The document feeder 405 feeds the document sheets set on the tray 406 one by one, and the scanner 113 scans the document image. The printer 114 prints the scanned image.

When downloading a musical score, the user selects the musical score download service and a musical score to be downloaded from the menu displayed on the operation unit 112, and inserts an amount of money. In this case, the user prints the musical score by these two operations. The user inserts an amount of money corresponding to the musical score download fee and printing fee separately in the first embodiment, but can insert an amount corresponding to these fees at once in the second embodiment to be described later.

<Software Arrangement of Multi-Functional Peripheral>

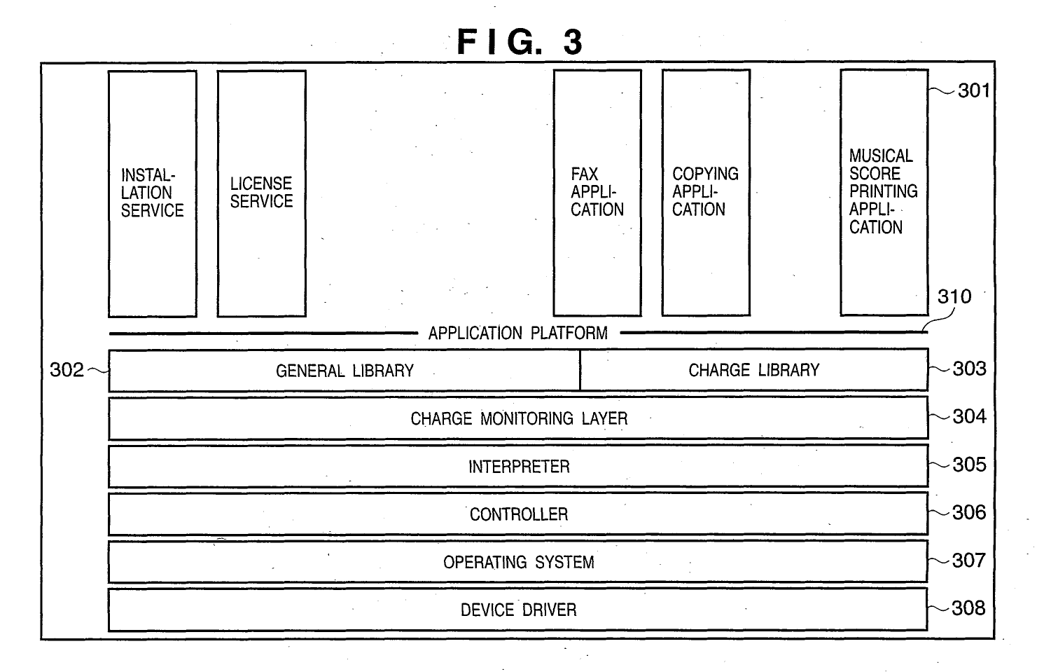

FIG. 3 is a block diagram of software installed in the multi-functional peripheral. A general application (to be also simply referred to as an application hereinafter) such as a musical score printing application 301 runs to implement a corresponding service. The application calls a necessary library contained in a general library 302 on the top layer of an application platform 310, implementing a function provided by the library. Note that the application platform 310 is not one application, but a set of interfaces corresponding to application programs provided by libraries. A charge monitoring layer 304 immediately below the library hooks a call for the library on the basis of the charge information table 200, and transfers a process to a charge library 303 together with parameters such as the unit cost, quantity, and message. The called library uses a device driver 308 and a function provided by an operating system 307, as needed. At this time, an interpreter 305 and controller 306 mediate the operating system 307 and device driver 308, but the first embodiment will omit a description of these intermediate layers. Note that a program implements the charge monitoring layer 304.

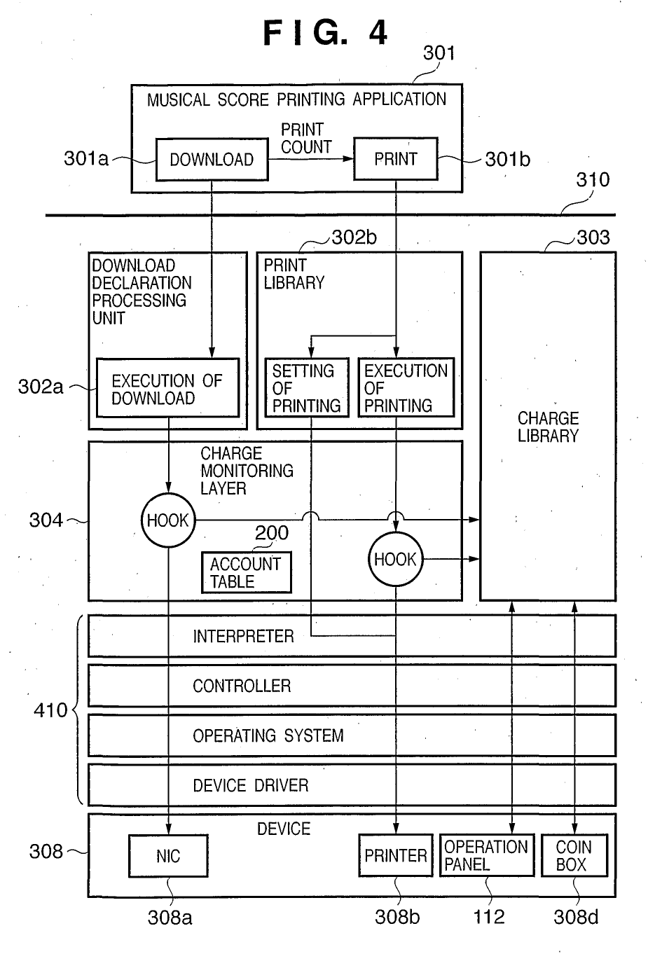

A process by the charge library 303 and operations before and after the process in an actual application will be explained. FIG. 4 is a view showing the schematic arrangement of the musical score printing application 301. FIG. 4 shows at once parts associated with download and printing serving as target paid functions. A download module 301a and print module 301b which execute corresponding functions in the musical score printing application 301 call a network library and print library 302b, respectively. In order to execute the functions, the respective libraries further call functions (including functions provided by devices) of the operating system via an intermediate layer 410.

The charge monitoring layer 304 monitors calls for functions (to be also referred to as processes or functions) by the respective libraries. The charge monitoring layer 304 hooks each function call, and transfers the process to the charge library 303. The charge monitoring layer 304 hooks all called functions. Whether to actually charge a user for a function is determined by looking up the charge information table 200 after hooking. In the example of FIG. 4, the print library calls two functions of setting and executing printing. The user is charged for only the print execution function, and is not charged for the print setting function. Depending on contents registered in the charge information table 200, the user may not be charged for the print execution function. However, the charge monitoring layer 304 hooks either function regardless of the contents of the charge information table 200, and determines whether to register the function. The charge library 303 has I/O interfaces mainly with the operation panel 112 and a coin box 308d, and prompts a user for a charge or confirms payment via these I/O interfaces. The network library calls the function of a NIC (network interface) 308a via the operating system. The charge monitoring layer 304 also hooks this function call.

<Operation by Charge Monitoring Layer>

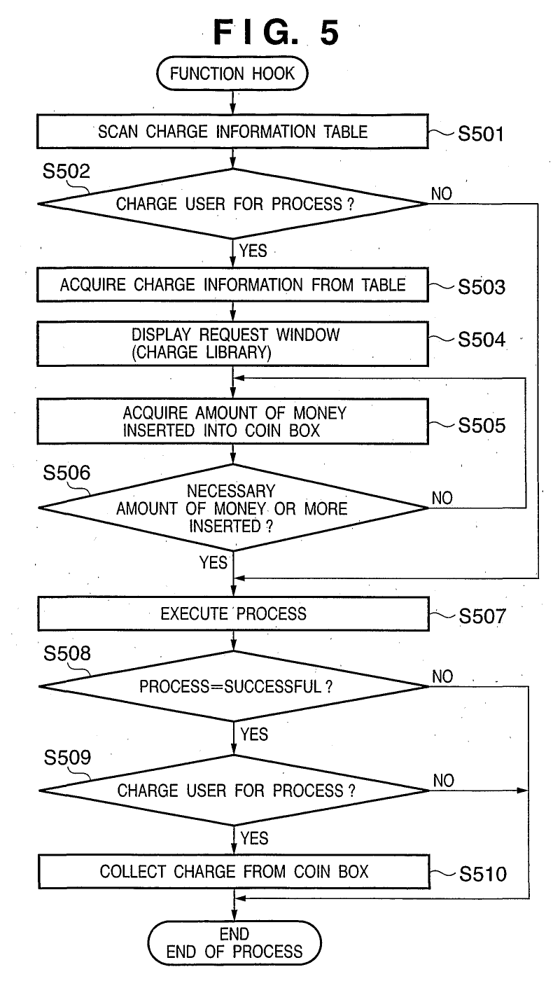

The charge library 303 executes a charging process as shown in FIG. 5. When the user selects the musical score download service and a musical score to be downloaded, the musical score download application starts. The musical score download application calls the musical score download function and print function for the selected musical score. The process in FIG. 5 shows procedures executed by the charge monitoring layer 304 and charge library 303 upon calling these functions. In the following description, the charge monitoring layer 304 executes steps not described to be executed by the charge library 303.

More specifically, when a library calls a predetermined function (or a function), the charge monitoring layer 304 hooks the call. For convenience in adding an application or library, the charge monitoring layer 304 may also hook a call for a function other than a predetermined one. When a library calls each function by calling a predetermined function using, e.g., the name of the function (function name) as a parameter, the charge monitoring layer 304 can specify whether to hook the function, by collating the function name serving as a parameter with a table representing whether to hook a function. The first embodiment also uses the charge information table 200 as a table representing whether to hook a function. The charge monitoring layer 304 hooks functions registered in the charge information table 200.

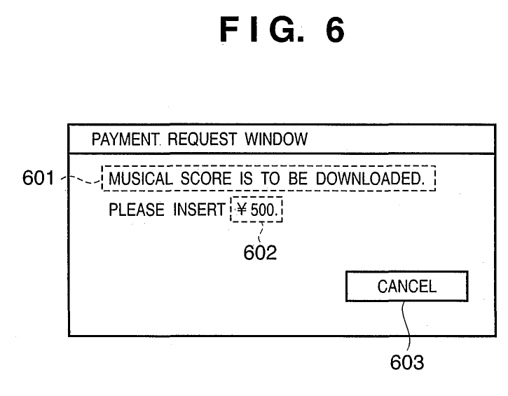

Upon the function call, the process in FIG. 5 starts. The charge monitoring layer 304 scans pieces of information, particularly function names in the charge information table 200 (S501). The charge information table 200 is downloaded in advance in the multi-functional peripheral in the first embodiment. Alternatively, the charge information table 200 in the charge information server 100 may be looked up via the network. The charge monitoring layer 304 determines whether the charge information table 200 holds the function as a result of scanning the charge information table 200 and the charge flag (also called a charge attribute) of the currently hooked process is ON (S502). If the charge information table 200 does not hold the function name, or even if it holds the function name but the charge attribute of the function is OFF, the process returns to continue the designated function (S507). If the charge information table 200 holds the function name and the charge attribute of the function is ON, the charge monitoring layer 304 reads charge information (fee and message) of the function from the charge information table 200 (S503). The charge monitoring layer 304 transfers the charge information as a parameter to the charge library 303, and executes the charge library 303. The charge library 303 executes steps S504 to S506. The charge information server 100 may contain the account table look-up function and charge calculation function as some functions of the charge library 303. In this case, the charge information server 100 receives via the network a declaration message issued by an application instructed to run in the multi-functional peripheral. The charge information server 100 looks up the charge information table 200 in correspondence with the message. The charge information server 100 may specify a paid function by looking up the charge information table 200, calculate the charge of the function, and notify the multi-functional peripheral of information necessary to display windows in FIGS. 6, 7, and 10 as an example of paid-function information. The multi-functional peripheral may acquire the paid-function information and determine the paid function of the application instructed to run.

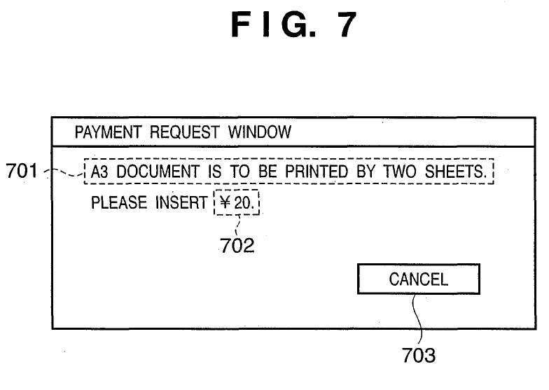

The charge library 303 displays payment request windows shown FIGS. 6 and 7 on the basis of the parameter (S504). More specifically, the charge library 303 displays a message on the first line, and displays an amount of money on the second line together with a character string “please insert . . . .” Messages 601 and 701 and money amounts 602 and 702 enclosed with dotted lines on the first line in FIGS. 6 and 7 are displayed on the basis of charge information. After displaying the payment request windows, the charge library 303 enters a coin box status monitoring loop.

The coin box has an interface for transferring a currently inserted amount of money to the charge library 303. The charge library 303 periodically acquires an inserted amount of money (S505). The charge library 303 determines whether the inserted amount of money is equal to or larger than the fee acquired from the charge information table 200 (S506). If the inserted amount of money is equal to or larger than the fee, the charge library 303 escapes from the status monitoring loop. Then, the charge library 303 returns the process to a step immediately after hooking by the charge monitoring layer 304. Step S507 is a process by the called function body. When the body process is to download a musical score, selected musical score data is downloaded from the musical score server 102 and saved in the hard disk or the like. If the body process is to print a musical score, musical score data is rendered and printed on an A3 print sheet.

After executing the original process, whether the process is successful is returned as an error code. The charge monitoring layer 304 monitors and determines the error code (S508). If the process is successful, the charge monitoring layer 304 determines whether to charge the user for the process (i.e., whether the function is registered in the charge information table 200 and the charge flag is ON) (S509). If the user is charged for the process, the charge monitoring layer 304 causes the charge library 303 to collect the charge into the safe out of the money inserted into the coin box. If the process fails, the charge monitoring layer 304 causes the charge library 303 to display an error message on the operation panel, without collecting the charge.

The above processes are process procedures, especially charging procedures in the musical score download service in the first embodiment. When the user receives this service, the image forming apparatus displays a payment request window in downloading and printing a musical score, and the user must insert money for each request. If the user inserts a requested amount of money, the image forming apparatus executes the function and receives the inserted money upon completion of the function.

If there is a newly added library or application, the above arrangement allows registering a function called by the library or application in the charge information table 200. This makes it possible to hook a function, determine whether to charge a user for the function, and if so, request the fee from the user. In other words, the charging process can be flexibly added in accordance with addition of a library or application. It is also easy to charge the user for an existing function, cancel charging, or change the unit cost.

The first embodiment can provide an image forming apparatus such as a copier which is suited to public use by collecting the charge of a service every time the user uses the image forming apparatus.

### Second Embodiment

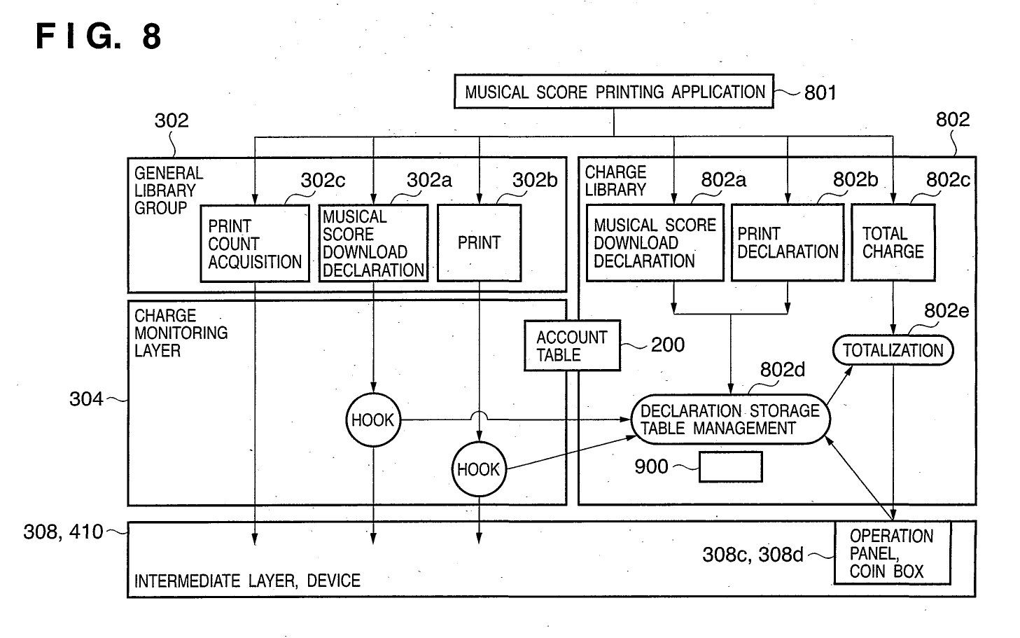

A multi-functional peripheral according to the second embodiment will be described with reference to FIGS. 8 to 10 and 12 to 14. The arrangement of the multi-functional peripheral and the network configuration are the same as those in the first embodiment. FIG. 8 is a collaboration view showing the software arrangement and process order in the second embodiment.

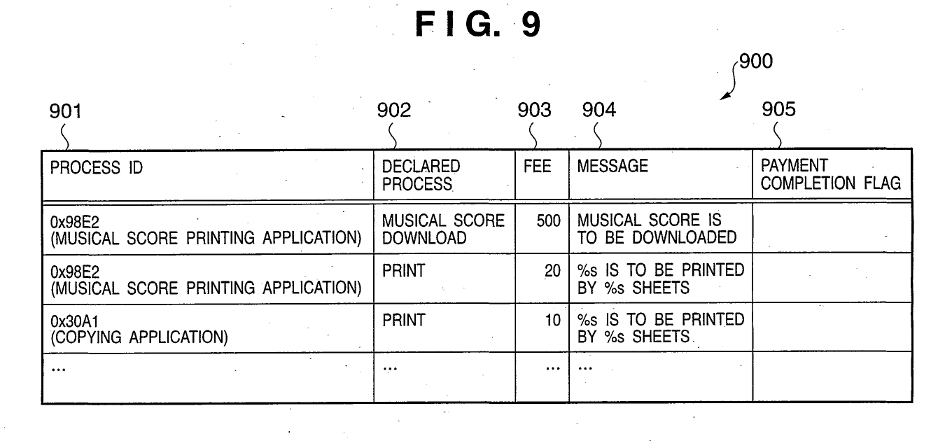

When the user starts a musical score printing application and selects a musical score to be printed, a print count acquisition unit 302c is called. This function is to acquire, via a network, count data saved in, e.g., a musical score server 102 together with musical score data. The print count is finalized by this function and used to calculate a fee. Then, a download declaration processing unit 302a in the network library is called to declare (or reserve) future download of the musical score. The download declaration processing unit 302a belongs to a charge library 802. A declaration storage table 900 stores the function name of the execution-declared download function, a process ID unique to an application 801 which has called the download declaration processing unit 302a, and charge information (fee and message) of the declared function in association with each other (FIG. 9). A declaration storage table management unit 802d manages the declaration storage table 900. The application similarly declares printing. At this time, the print count acquisition unit 302c transfers the acquired print count as a parameter to a print declaration processing unit 302b. The print declaration processing unit 302b saves a fee corresponding to the print count in the declaration storage table 900 in association with the function name of the execution-declared print function, and the process ID unique to the application 801 which has called the print declaration processing unit 302b.

Since the two processes (download and printing) are all processes for which the user is charged and both of the processes are declared, the musical score printing application 801 calls a total charging process. The musical score printing application 801 executes, e.g., a declaration process fixed for a predetermined function. Alternatively, the musical score printing application 801 determines a charged function by looking up a charge information table 200, and executes the declaration process for the target function. For this purpose, the musical score printing application 801 can employ a method of commonly executing, e.g., the procedures of the declaration processing unit and transferring a declared function name as a parameter to the declaration processing unit.

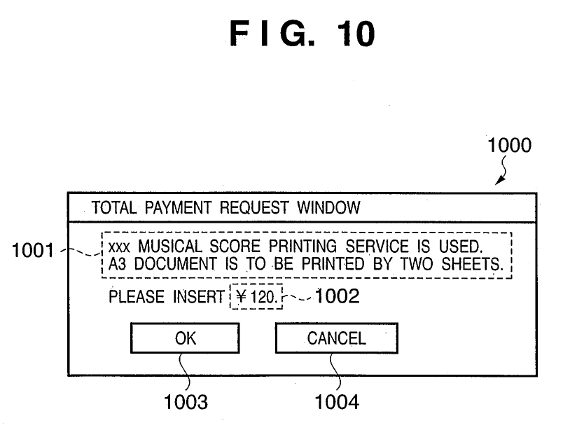

A total charge processing unit 802c extracts all fees contained in declarations corresponding to the process ID of an application which has called the total charge processing unit 802c from the declaration storage table 900. The total charge processing unit 802c totals up the extracted fees to calculate the total fee. The total charge processing unit 802c composites corresponding declaration messages to generate a new message. The total charge processing unit 802c displays a payment request window using the total fee and the newly composited message (FIG. 10). In FIG. 10, a message 1001 is a newly composited message. An amount 1002 of money is the total fee. The user responds to this dialog by pressing an OK button 1003 or cancel button 1004.

After the user inserts an amount of money corresponding to the total fee, a totalization processing unit 802e detects this, and marks the column of the payment completion flag in the declaration storage table 900 to represent that the user paid the fee. As a result, the total charging process ends, and the control returns to the musical score printing application 801.

The musical score printing application 801 calls the download declaration processing unit 302a in the network library and downloads a musical score. A charge monitoring layer 304 hooks the download function. Unlike the first embodiment, a declaration storage table management unit 802d of the charge library 802 takes over the process after hooking. The declaration storage table management unit 802d confirms whether the user completes payment of the musical score download function to be currently processed. For confirmation, the declaration storage table management unit 802d refers to process IDs in the declaration storage table and a declared function name, and searches for a line on which the process ID of the application calling the download function matches the called function name. If the declaration storage table management unit 802d detects a matching line, it refers to the payment completion flag on the line and determines whether payment is “complete”. If payment is complete, the declaration storage table management unit 802d deletes, from the table, the line holding the declaration, and executes the musical score download process. If no matching line exists, or even if the matching line exists but payment is not complete, no declaration is made, or fees are not totaled up. In this case, the charge library 802 executes a charging process for the musical score download function, similar to the procedures in the first embodiment. Upon completion of the charging process, the charge library 802 executes the musical score download function.

The print function is executed similarly to the download function except that it is also determined whether a print count parameter transferred in declaration matches a print count parameter subjected to a process by an actual function call, in addition to whether payment is complete.

FIG. 9 shows an example of the declaration storage table 900. The declaration storage table 900 has a process ID 901, a declared process (corresponding to a function in the first embodiment) 902, a fee 903, a message 904, and a payment completion flag 905. The process ID is that of a declaring application, and has a unique value. Considering a case of parallel-executing a plurality of identical applications, it is desirable to dynamically assign even the same application with a different process ID during execution. The column of the declared process 902 stores an identification name common to a function name in the charge information table 200. The columns of the fee 903 and message 904 save a fee and message which are read out from the charge information table 200 and correspond to a target function. The payment completion flag 905 is set in the above-described manner.

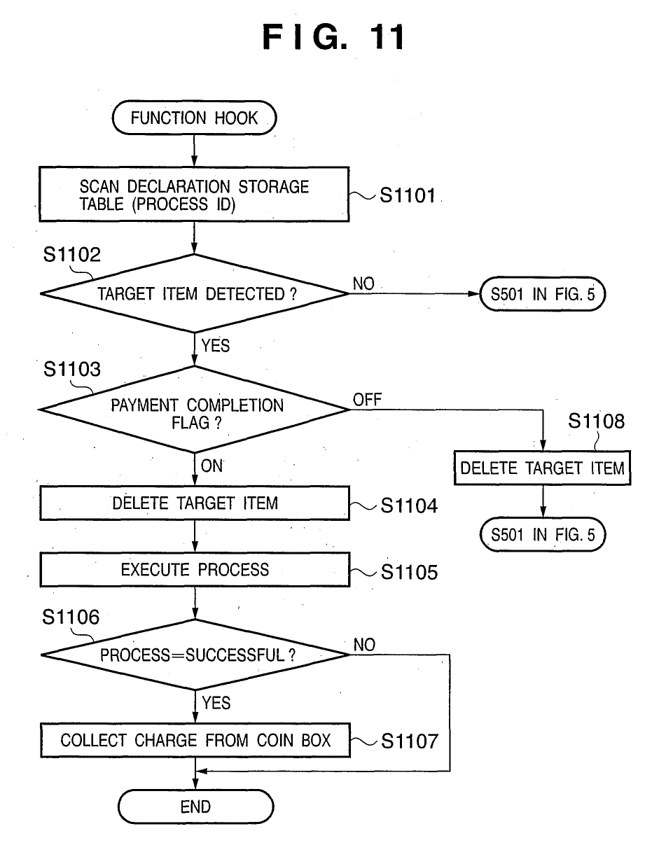

FIG. 11 is a flowchart showing process procedures to hook a function call from a library by the charge monitoring layer 304 in the second embodiment. The procedures in FIG. 11 represent a process when actually calling a function, and the declaration storage table 900 is created by the above-described declaration process. More specifically, a declaration processing unit 802b or the like receives, as parameters from the application program, the name of a function to be executed, a quantity (e.g., a sheet count) serving as a coefficient of the unit cost, and the process ID of the application. The declaration processing unit saves, the program ID, function name, fee, and message in the declaration storage table in correspondence with each other. At this time, the application transfers the fee and message as parameters by looking up the charge information table 200. In the second embodiment, however, the declaration processing unit reads out a message and unit cost corresponding to a function name transferred from the application by looking up the charge information table 200. The fee is calculated by multiplying a quantity transferred as a parameter by the unit cost. The declaration storage table holds these pieces of information.

In FIG. 11, the charge monitoring layer 304 scans the declaration storage table 900 to search for the process ID of an application which has called a function to be executed (S1101). If the charge monitoring layer 304 detects the process ID, it transfers the process ID and function name to the charge library and causes the charge library to execute steps S1102 to S1104. The charge library 802 determines whether the declaration storage table 900 has a line containing the transferred process ID and function name (S1102). If the declaration storage table 900 has the target line, the charge library 802 tests the payment completion flag (S1103). If the payment completion flag is ON, the charge library 802 deletes the line from the declaration storage table 900 (S1104). The charge library 802 returns the process to a step immediately after hooking of the function, and the charge monitoring layer 304 executes the called function (S1105). The charge monitoring layer 304 determines whether the process is successful (S1106). If the process is successful, the charge monitoring layer 304 causes the charge library 802 to collect an amount of money corresponding to the fee from the coin box and return the change (S1107).

If the charge library 802 determines in step S1103 that the payment completion flag is OFF, it determines that the user does not complete any payment, and thus deletes the target line from the declaration storage table. After that, the process by the charge library 802 ends, and the process branches to step S501 in FIG. 5. When the user may insert some of money into the coin box, it may be controlled to return all the amount of money inserted into the coin box. As a result, the charging process is executed by the same procedures as those of the charging process in the first embodiment. If the charge library 802 determines in step S1102 that no target line exists, i.e., that no declaration is made, the process also branches to step S501 in FIG. 5.

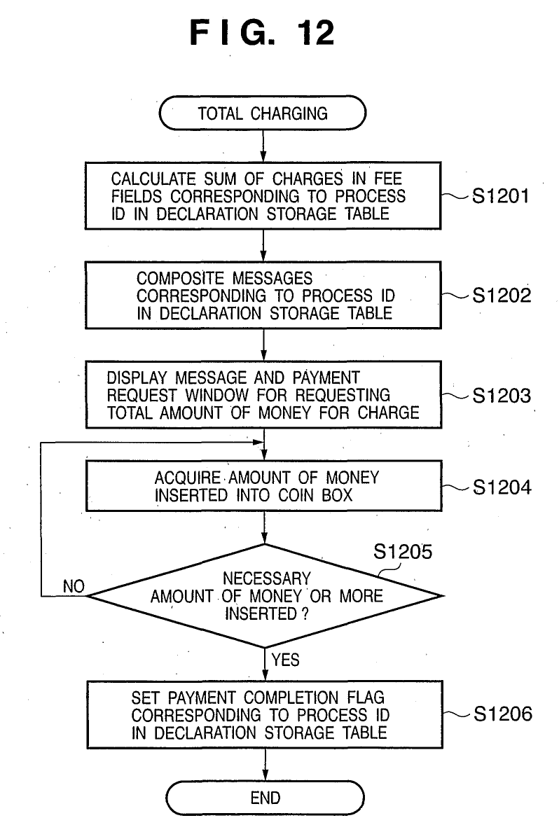

FIG. 12 shows process procedures by the total charge processing unit 802c. When the total charge processing unit 802c is called, it calculates, on the basis of the declaration storage table 900, the sum of charges in fee fields corresponding to the process ID of an application which has called the total charge processing unit 802c (S1201). The total charge processing unit 802c reads out, from the declaration storage table 900, messages corresponding to the process ID of the application which has called the total charge processing unit 802c, and composites the messages (S1202). The total charge processing unit 802c displays a payment request window as shown in FIG. 10 using the total fee calculated in step S1201 and the message composited in step S1202 (S1203). The total charge processing unit 802c reads out the amount of money inserted into the coin box (S1204), and determines whether the user inserts a necessary amount of money or more (S1205). If the total charge processing unit 802c determines that the user inserts a necessary amount of money or more, it sets “complete” at the payment completion flags of all functions corresponding to the process ID of the application which has called the total charge processing unit 802c (S1206).

By the above procedures, the image forming apparatus can request at once a user to pay a total amount of money charged for respective paid functions of a service (application). The image forming apparatus can, therefore, charge the user for each service of a new function in addition to copying. The second embodiment can provide an image forming apparatus such as a copier which can collect the charge every time it provides one service and is suited to public use. By providing a platform having a charging mechanism shared between provided functions, the second embodiment can prevent an increase in the burden of application development accompanying a charging process for addition of a new function.

### Third Embodiment

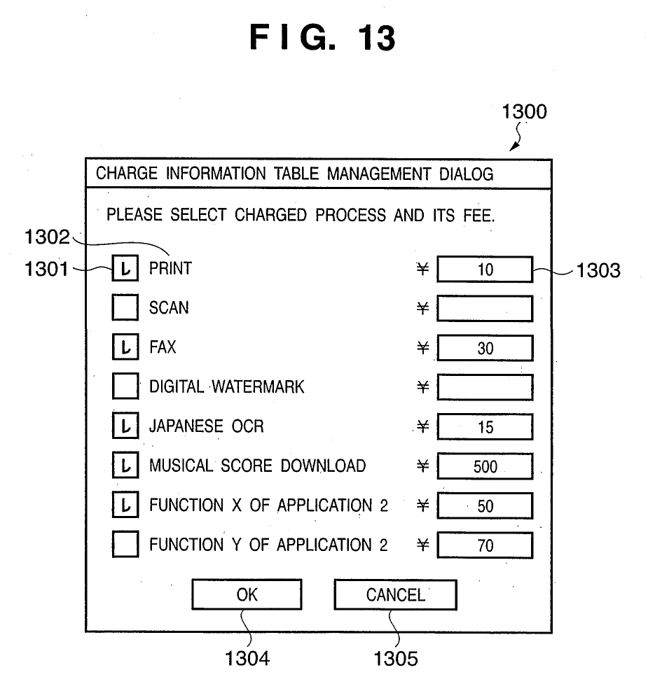

In the first and second embodiments, the charge information table 200 exists in the network server. In the first and second embodiments, the charge information server 100 reads out and looks up the charge information table 200, and unitarily performs management. When changing an application installed in each store for the purpose of differentiation, it is desired to store the charge information table 200 in an HDD incorporated in a multi-functional peripheral and manage it at each store. In this case, only the administrator prepares a resident system service, i.e., a charge information table management service, and performs an operation to, for example, change the payment structure through the UI window (FIG. 13) of the service.

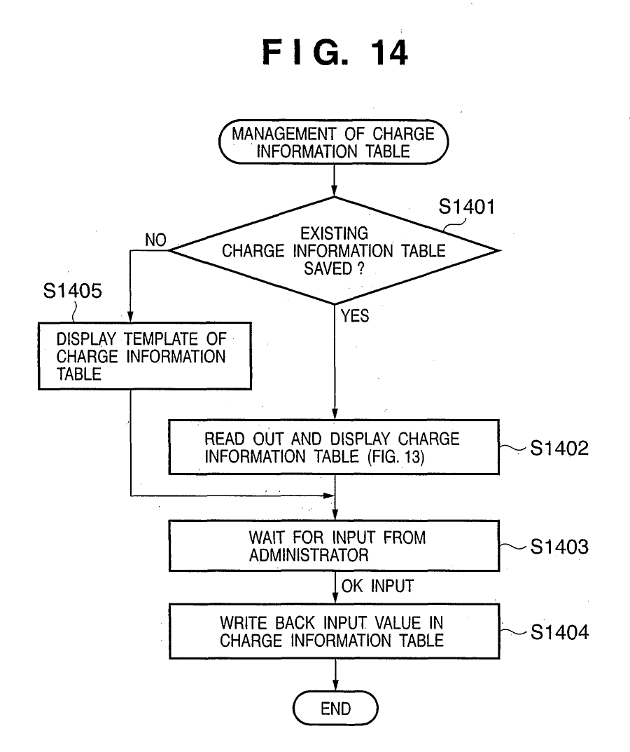

FIG. 14 shows an example of process procedures by the charge information table management service. In step S1401, the charge information table management service determines whether the storage unit, e.g., HDD of the multi-functional peripheral saves an existing charge information table. If there is an existing charge information table, the charge-information table management service reads the charge information table and displays the setting window (FIG. 13) in accordance with the contents of the table (S1402). The window displays a charge flag 202, function name 201, and fee 203 in a charge flag field 1301, function name field 1302, and fee field 1303, respectively. This window allows the administrator to perform an operation to change setting contents (S1403). Note that the window may also allow the administrator to set a message, but the message is fixed in the third embodiment. In FIG. 13, items changeable by the administrator are only the charge flag and fee, but the function name can also be added or deleted.

If the user presses an OK button 1304, the charge information table management service writes back a value input by the press in a charge information table 200 (S1404).

If the charge information table management service determines that there is no existing charge information table, the process branches to step S1405. In step S1405, the charge information table management service displays a template which holds default values of the declaration storage table, as shown in FIG. 13 (S1405). Thereafter, the process branches to step S1403.

By the above procedures, the administrator can change the charge information table. The administrator can also add or delete a message or new function, in addition to the fee and whether to charge a user for a function. Hence, the administrator can more flexibly change the fee of a charging process and a charging target.

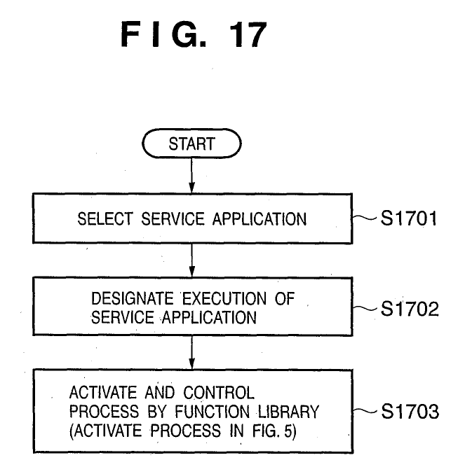

FIG. 17 is a flowchart of a process by a platform program and musical score printing application. FIG. 17 shows the flow of a service execution process. Assume that an operation panel 112 of the multi-functional peripheral displays a list of service providing applications. The application platform program in FIG. 3 serving as an example of a designation means selects a service providing application on the basis of a selection instruction by a user through the operation panel 112. In the third embodiment, the process starts when the user uses the operation panel 112 of the multi-functional peripheral to select a service providing application on the platform program in FIG. 3. Assume that the platform program recognizes that the user selected the musical score printing application (S1701). Then, the process advances to S1702 and shifts to the musical score application. When a musical score printing application 301 recognizes in S1702 that the user presses an execution button on the operation panel 112 of the musical score print function of the musical score printing application 301, the process advances to S1703. In S1703, the musical score printing application controls a charge library 303 to activate it. For example, in order to call a predetermined library by the musical score printing application 301, the charge library 303 may start the charging process in FIG. 5.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-265941 filed on Sep. 13, 2005 which is hereby incorporated by reference herein in its entirety.

1-29. (canceled)

30. An image forming apparatus comprising:
an application platform on which an application program is executable, the application program providing paid-functions of which usage is charged, having:
a declaration storage unit, configured to store a declared paid-function and a charge amount based on usage of the paid-function in accordance with a declaration of calling the paid-function, and
a totalization unit, configured to sum up charge amounts based on the usages of the paid-functions stored in said declaration storage unit so as to calculate a total charge amount corresponding to the application program in response to a totalization message from the application program;
a display unit, configured to display details of usages of the declared paid-functions and the total charge amount calculated by said totalization unit in response to the declaration of calling the paid-function from the application program; and
a permission unit, configured to permit the paid-function to be executed in response to payment of money corresponding to the total charge amount after displaying by said display unit.

31. An apparatus according to claim 30, further comprising:
a management unit, configured to manage a charge table for identifying paid-functions; and
an update unit, configured to update the charge table based on input by a user via a user interface provided by said display unit,
wherein said declaration storage unit stores the declared paid-function and a charge amount based on a usage of the declared paid-function when it is determined that the function called by the application program is a paid-function based on the management table.

32. A method of controlling an image forming apparatus having an application platform on which an application program is executable, the application program providing paid-functions of which usage is charged, said method comprising:
a declaration storing step of storing a declared paid-function and a charge amount based on usage of the paid-function in accordance with a declaration of calling the paid-function;
a totalizing step of summing up charge amounts based on the usages of the paid-functions stored in said declaration storing step so as to calculate a total charge amount corresponding to the application program in response to a totalization message from the application program;
a displaying step of displaying details of usages of the declared paid-functions and the total charge amount calculated in said totalizating step in response to the declaration of calling the paid-function from the application program; and
a permitting step of permitting the paid-function to be executed in response to payment of money corresponding to the total charge amount after displaying in said displaying step.

33. A method according to claim 32, further comprising:
a managing step of managing a charge table for identifying paid-functions; and
an updating step of updating the charge table based on input by a user via a user interface provided in said displaying step,
wherein the declared paid-function and a charge amount based on a usage of the declared paid-function are stored in said declaration storing step when it is determined that the function called by the application program is a paid-function based on the management table.

34. An image forming apparatus on which an application program providing paid-functions of which usages are charged, comprising:
a storage unit, configured to store a paid-function provided by the application program and a charge amount based on usage of the paid-function;
a totalization unit, configured to sum up charge amounts stored in said storage unit based on usages of paid-functions corresponding to the application program so as to calculate a total charge amount;
a display unit, configured to display details of usages of the paid-functions provided by the application program and the total charge amounts calculated by said totalization unit; and
a permission unit, configured to permit the paid-functions to be executed in response to payment of money corresponding to the total charge amount after displaying by said display unit.

35. A method of controlling an image forming apparatus on which an application program providing paid-functions of which usages are charged, comprising:
a storing step of storing a paid-function provided by the application program and a charge amount based on usage of the paid-function;
a totalizing step of summing up charge amounts stored in said storage unit based on usages of paid-functions corresponding to the application program so as to calculate a total charge amount;
a displaying step of displaying details of usages of the paid-functions provided by the application program and the total charge amounts calculated in said totalizing step; and
a permitting step of permitting the paid-functions to be executed in response to payment of money corresponding to the total charge amount after displaying in said displaying step.

36. A computer readable medium on which a program is stored, the program causing a computer to perform a method of controlling an image forming apparatus on which an application program providing paid-functions of which usages are charged, said method comprising:
a storing step of storing a paid-function provided by the application program and a charge amount based on usage of the paid-function;
a totalizing step of summing up charge amounts stored in said storage unit based on usages of paid-functions corresponding to the application program so as to calculate a total charge amount;
a displaying step of displaying details of usages of the paid-functions provided by the application program and the total charge amounts calculated in said totalizing step; and
a permitting step of permitting the paid-functions to be executed in response to payment of money corresponding to the total charge amount after displaying in said displaying step.
